(19) United States
(12) Patent Application Publication
(10) Pub. No.: US 2011/0230378 A1
(43) Pub. Date: Sep. 22, 2011

(54) IMPROVED POLYMER DISPERSIONS

(75) Inventors: Thomas Schimmel, Darmstadt (DE); Wolfgang Tschepat, Darmstadt (DE); Stephan Fengler, Frankfurt (DE)

(73) Assignee: EVONIK ROHMAX ADDITIVES GMBH, Darmstadt (DE)

(21) Appl. No.: 12/599,996

(22) PCT Filed: Feb. 13, 2008
(86) PCT No.: PCT/EP2008/051697

§ 371 Date: Nov. 13, 2009

(30) Foreign Application Priority Data
May 31, 2007 (DE) 10 2007 025 604.5

(51) Int. Cl. C10M 143/00; C08K 5/10; C08K 5/11; C08K 5/46

(52) U.S. Cl. 508/505; 524/315; 524/313; 524/83

(57) ABSTRACT

The present invention relates to polymer dispersions comprising A) at least one dispersed polyolefin, B) at least one dispersion component, C) mineral oil and D) at least one glyceryl ester derived from an unsaturated carboxylic acid having from 8 to 30 carbon atoms. The inventive polymer dispersions are notable for very good low-temperature performance. In addition, the polymer dispersions can be prepared in a particularly energy-saving manner. The present invention further relates to processes for the preparation of and to the use of these polymer dispersions.

The invention relates to improved polymer dispersions, to processes for producing these dispersions and to the use thereof.

One way of improving the viscosity index of motor oils is to use polyolefins. Typical addition rates in motor oils are, according to the thickening action of the polymers, about 0.5-6% by weight. Particularly inexpensive viscosity index improvers are olefin copolymers (OCPs) which are formed predominantly from ethylene and propylene, or hydrogenated block copolymers (HSDs) of dienes and styrene.

The excellent thickening action of these polymer types is countered by laborious processability in the production of lubricant oil formulations. Especially the poor solubility in the oils which form the basis of the formulations presents difficulties. In the case of use of solid polymers which have not been predissolved, the result is thus long stirring-in periods, for which there is a reliance on the use of specific stirrer and/or pregrinder mechanisms.

When concentrated polymers already predissolved in oil are used as commercial supply forms, only a 10-15% supply form of the OCPs or HSDs is achievable. Higher concentrations are accompanied by excessively high viscosities of the solutions (>15 000 mm²/s at room temperature) and are therefore effectively no longer manageable. Especially with this background, highly concentrated dispersions of olefin copolymers and hydrogenated diene/styrene copolymers have been developed.

The dispersion technology described allows the production of polymer solutions with more than 20% OCP or HSD content at viscosities which allow convenient incorporation into lubricant oil formulations. In principle, the synthesis of such systems includes the use of a so-called emulsifier or of a dispersing component. Customary dispersing components include OCP and HSD polymers, onto which alkyl methacrylates or alkyl methacrylate/styrene mixtures have usually been grafted. Additionally known are dispersions in which a solvent which is a better solvent for the methacrylate constituent of the dispersion and a worse solvent for the OCP or HSD component is used. Such a solvent together with the methacrylate component of the product forms the main constituent of the continuous phase of the dispersion. Considered in formal terms, the OCP or HSD constituent constitutes the main constituent of the discontinuous or disperse phase.

The prior art is considered to include the following documents:

U.S. Pat. No. 4,149,984

EP-A-0 008 327

DE 32 07 291

DE 32 07 292

U.S. Pat. No. 5,130,359

WO 2004/037954

WO 2004/037955

WO 2004/037956

U.S. Pat. No. 4,149,984 describes a process for producing lubricant oil additives by improving the compatibility between polyalkyl methacrylates, referred to hereinafter as PAMAs, and polyolefins. The proportion by weight of the PAMA is 50-80%, that of the polyolefin 20-50%. The total polymer content of the dispersion is 20-55%. The use of dispersing monomers such as N-vinylpyrrolidone for grafting is likewise mentioned.

Before this application, it was known that methacrylates can be polymerized onto a polyolefin by grafting (DT-B 1 235 491).

EP-A-0 008 327 protects a process for producing lubricant oil additives based on a hydrogenated block copolymer of conjugated dienes and styrene, wherein, in a first stage, styrene and alkyl methacrylates or exclusively alkyl methacrylates are grafted onto the hydrogenated block copolymer, and, in a second stage, an additional graft stage (e.g. N-vinylpyrrolidone) is formed. The proportion of the hydrogenated block copolymer in the total polymer content is 5-55% by weight, that of the first graft stage consisting of PAMA/styrene 49.5-85%, and that of the second graft stage 0.5-10%.

Document DE 32 07 291 describes processes which enable an increased olefin copolymer input. The olefin copolymer content should be 20-65% in relation to the total weight of the dispersion. The subject matter of the invention is that use of suitable solvents which are poor solvents for olefin copolymers and good solvents for PAMA-containing components allows more highly concentrated dispersions to be obtained. DE 32 07 291 should be understood as a process patent, which more particularly describes the production of the dispersions.

DE 32 07 292 corresponds essentially to DE 32 07 291, but should if anything be considered as protection of particular copolymer compositions. These compositions are produced by a process analogous to that described in DE 32 07 291.

U.S. Pat. No. 5,130,359 relates to polymer dispersions which comprise a polyolefin, a dispersing component and an organic liquid, the solubility of the polyolfin in the organic liquid being at most 10%. The suitable organic liquids include especially esters, glycerol also being mentioned as an alcohol component of the ester. However, no examples of glyceryl esters are given. The acids suitable for preparing the esters include especially short-chain carboxylic acids. Esters of long-chain unsaturated carboxylic acids are not detailed in U.S. Pat. No. 5,130,359. In addition, the dispersion according to U.S. Pat. No. 5,130,359 may comprise mineral oil as an optional component, although the proportion must be sufficiently low that the solubility limit detailed above is not exceeded. For production of the dispersions, solutions of the polyolefin are generally used, the solvent being distilled off during the dispersing. This requires a relatively large amount of energy for production of the dispersion.

Publication WO 2004/037954 discloses polymer dispersions which, in addition to a polyolefin, a dispersing component and a carrier medium, additionally contain a compound with a dielectric constant greater than or equal to 9. This can achieve an improvement in the viscosity, which allows the proportion of polyolefin to be increased. The use of long-chain carboxylic esters of glycerol is not described in this document.

In addition, document WO 2004/037955 describes polymer dispersions which, as well as a polyolefin, a dispersing component, additionally comprise a mixture which contains mineral oil and at least one compound comprising (oligo)oxyalkyl groups. Compounds comprising the (oligo)oxyalkyl groups include especially esters, which may be derived, for example, from mono- and dicarboxylic esters. These esters contain, as the alcohol radical, preferably diols or polyalkylene glycols. Such dispersions exhibit particularly high stability at low temperatures. The use of long-chain carboxylic esters of glycerol is not described in this document.

Moreover, the document WO 2004/037956 describes polymer dispersions which contain a polyolefin, a dispersing component, an ester and an ether comprising (oligo)oxyalkyl groups, the ratio of ester to ether being in the range from 30:1 to 1:30. The use of long-chain carboxylic esters of glycerol is not described in this document. The dispersions described in this publication likewise exhibit a particularly high stability at high temperatures.

The polymer dispersions described in the prior art already exhibit a good profile of properties. Especially the low-temperature properties thereof are, however, in need of improvement. For instance, the dispersions detailed above in many cases exhibit turbidity if they are stored at temperatures below 10° C. This turbidity is in many cases reversible, but this can give rise to the necessity to heat the dispersion with expenditure of energy.

In addition, some dispersions exhibit a relatively high viscosity at a high proportion of polyolefin. According to WO 2004/037954, this viscosity can be reduced by adding polar substances. However, these dispersions in many cases exhibit a rise in viscosity as the dispersion is cooled, as demonstrated especially by the examples adduced in WO 2004/037954.

Furthermore, it is necessary to produce the dispersions described above at very high temperatures, and very long dispersing times are necessary in many cases. The production of the known dispersions is therefore relatively expensive. Alternatively, it is possible according to the prior art to work with very high stirrer outputs. Accordingly, it was an object of the present invention to provide dispersions which can be obtained with a particularly low energy requirement, especially at relatively low temperatures and with short dispersion times.

It was a further object of the present invention to provide polymer dispersions with a low viscosity coupled with high polyolefin content. The higher the OCP or HSD content, the higher the viscosity of the dispersion generally is. On the other hand, a high content of these polymers is desirable in order to lower the transport costs. It should be considered in this context that a lower viscosity allows simpler and more rapid mixing of the viscosity index improvers into the base oil. Polymer dispersions which have a particularly low viscosity should therefore be provided.

In addition, the processes for producing the aforementioned polymer dispersions are relatively difficult to control, such that particular specifications can be complied with only with difficulty. Accordingly, polymer dispersions whose viscosity can be adjusted readily to given values should be created.

It was a further object to specify polymer dispersions which have a high content of polyolefins, especially of olefin copolymers and/or hydrogenated block copolymers.

Furthermore, the polymer dispersions should be producible simply and inexpensively, and it should especially be possible to use commercially available components. In this context, production should be possible on the industrial scale, without new plants or plants of complex construction being required for this purpose.

These objects and further objects which are not stated explicitly but which are immediately derivable or discernible from the connections discussed herein by way of introduction are achieved by polymer dispersions having all features of claim 1. Appropriate modifications to the inventive polymer dispersions are protected in the dependent claims which refer back to claim 1. With regard to the process for producing polymer dispersions, claim 32 provides a solution to the underlying problem, while claim 37 protects a preferred use of a polymer dispersion of the present invention.

By virtue of polymer dispersions comprising
A) at least one dispersed polyolefin,
B) at least one dispersing component,
C) mineral oil and
D) at least one glyceryl ester derived from an unsaturated carboxylic acid having 8 to 30 carbon atoms,
   it is possible in a not immediately foreseeable manner to provide polymer dispersions which have particularly good low-temperature properties. For instance, the inventive dispersions exhibit a low viscosity at low temperatures. Furthermore, opacity occurs only to a minor degree at very low temperatures.

At the same time, the inventive polymer dispersions allow a series of further advantages to be achieved. These include:
The production of the inventive dispersions requires a comparatively low energy expenditure. Thus, low dispersion temperatures and short dispersion times in particular are sufficient for production. Moreover, the dispersion can also be produced using solid polyolefin.
The inventive polymer dispersions may comprise particularly high proportions of polyolefins which have viscosity index-improving action or, in lubricant oils, thickening action.
The polymer dispersions of the present invention can be adjusted to a given viscosity in a particularly simple manner.
The polymer dispersions comprise a high proportion of biodegradable, nontoxic and inexpensive components. Occupational hygiene and environmental friendliness can therefore be improved compared to the prior art dispersions.
Polymer dispersions according to the subject matter of the present invention exhibit a low viscosity, which is also maintained at low temperatures.
The polymer dispersions of the present invention can be produced particularly easily and simply. This can be done using customary industrial scale plants.

Component A)

As component A) which is essential to the invention, the polymer dispersion comprises polyolefins which preferably have a viscosity index-improving or thickening action. Such polyolefins have been known for some time and are described in the documents cited in the prior art.

These polyolefins include especially polyolefin copolymers (OCPs) and hydrogenated styrene-diene copolymers (HSDs).

The polyolefin copolymers (OCPs) for use in accordance with the invention are known per se. They are primarily polymers formed from ethylene, propylene, isoprene, butylene and/or further olefins having 5 to 20 carbon atoms, as have already been recommended as VI improvers. The copolymers which contain diene components are generally hydrogenated in order to reduce the oxidation sensitivity and the crosslinking tendency of the polymers.

The molecular weight Mw is generally 10 000 to 300 000, preferably between 50 000 and 150 000. Such olefin copolymers are described, for example, in German published specifications DE-A 16 44 941, DE-A 17 69 834, DE-A 19 39 037, DE-A 19 63 039 and DE-A 20 59 981.

Particularly good usability is possessed by ethylene-propylene copolymers, though the use of terpolymers with tertiary components, such as ethylidenenorbornene (cf. Macromolecular Reviews, Vol. 10 (1975)), is also known. However, their tendency to crosslink in the course of the aging process should also be taken into account. The distribution may be substantially random; however, it is also advantageously possible to employ sequence polymers with ethylene blocks. The ratio of the ethylene-propylene monomers is variable within certain limits, which can be set at about 75% for ethylene and about 80% for propylene as the upper limit. Owing to a tendency to reduced solubility in oil, polypropylene homopolymers are already less suitable than ethylene-propylene copolymers. In addition to polymers with predominantly atactic propylene incorporation, those with more marked isotactic or syndiotactic propylene incorporation are also usable.

Such products are available commercially, for example under the trade names Dutral® CO 034, Dutral® CO 038, Dutral® CO 043, Dutral® CO 058, Buna® EPG 2050 and Buna® EPG 5050.

Hydrogenated styrene-diene copolymers (HSDs) are likewise known, these polymers being described, for example, in DE 21 56 122. They are generally hydrogenated isoprene- or butadiene-styrene copolymers. The ratio of diene to styrene is preferably in the range from 2:1 to 1:2, more preferably approx. 55:45. The molecular weight Mw is generally 10 000 to 300 000, preferably between 50 000 and 150 000. The proportion of double bonds after the hydrogenation is, in a particular aspect of the present invention, at most 15%, more preferably at most 5%, based on the number of double bonds before the hydrogenation.

Hydrogenated styrene-diene copolymers can be obtained commercially under the trade names ®SHELLVIS 50, 150, 200, 250 or 260.

In general, the proportion of components A) is at least 20% by weight, preferably at least 30% by weight and more preferably at least 40% by weight, without any intention that this should impose a restriction.

Component B)

Component B) is constituted by at least one dispersing component, and this component can frequently be considered as a block copolymer. At least one of these blocks preferably has a high compatibility with the above-described polyolefins of component A), given that at least one further block among those present in the dispersing component has only a low compatibility with the above-described polyolefins. Such dispersing components are known per se, preferred compounds being described in the aforementioned prior art.

The radical compatible with component A) generally exhibits nonpolar character, whereas the incompatible radical is polar in nature. In a particular aspect of the present invention, preferred dispersion components can be regarded as block copolymers which comprise one or more A blocks and one or more X blocks, said A block comprising olefin copolymer sequences, hydrogenated polyisoprene sequences, hydrogenated copolymers of butadiene/isoprene or hydrogenated copolymers of butadiene/isoprene and styrene, and said X block comprising polyacrylate, polymethacrylate, styrene, α-methylstyrene or N-vinylheterocyclic sequences and/or sequences of mixtures of polyacrylate, polymethacrylate, styrene, α-methylstyrene or N-vinylheterocycles.

Preferred dispersing components can be prepared by graft polymerization, by grafting polar monomers onto the above-described polyolefins, especially onto the OCPs and HSDs. To this end, the polyolefins can be pretreated by mechanical or/and thermal degradation.

The polar monomers include especially (meth)acrylates and styrene compounds.

The expression “(meth) acrylates” includes methacrylates and acrylates, and mixtures of the two.

In a particular aspect of the present invention, in the grafting reaction, the monomer composition used comprises one or more (meth)acrylates of the formula (I)

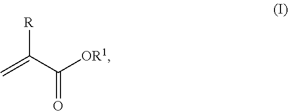

in which R is hydrogen or methyl and R¹ is hydrogen, a linear or branched alkyl radical having 1 to 40, preferably 1 to 24, carbon atoms.

The preferred monomers of the formula (I) include (meth)acrylates which derive from saturated alcohols, such as methyl(meth)acrylate, ethyl(meth)acrylate, n-propyl(meth)acrylate, isopropyl(meth)acrylate, n-butyl(meth)acrylate, tert-butyl(meth)acrylate, pentyl(meth)acrylate, hexyl(meth)acrylate, 2-ethylhexyl(meth)acrylate, heptyl(meth)acrylate, 2-tert-butylheptyl(meth)acrylate, octyl(meth)acrylate, 3-isopropylheptyl(meth)acrylate, nonyl(meth)acrylate, decyl(meth)acrylate, undecyl(meth)acrylate, 5-methylundecyl(meth)acrylate, dodecyl(meth)acrylate, 2-methyldodecyl(meth)acrylate, tridecyl(meth)-acrylate, 5-methyltridecyl(meth) acrylate, tetradecyl(meth)acrylate, pentadecyl(meth)acrylate, hexadecyl(meth)acrylate, 2-methylhexadecyl(meth)acrylate, heptadecyl(meth) acrylate, 5-isopropylheptadecyl(meth)acrylate, 4-tert-butyloctadecyl(meth)acrylate, 5-ethyloctadecyl(meth)acrylate, 3-isopropyloctadecyl(meth)acrylate, octadecyl(meth)acrylate, nonadecyl(meth)acrylate, eicosyl(meth)acrylate, cetyleicosyl(meth)acrylate, stearyleicosyl(meth)acrylate, docosyl(meth)acrylate and/or eicosyltetratriacontyl(meth)-acrylate; (meth)acrylates which derive from unsaturated alcohols, for example 2-propynyl(meth)acrylate, allyl(meth)-acrylate, vinyl(meth)acrylate, oleyl(meth)acrylate; cycloalkyl(meth)acrylates such as cyclopentyl (meth)-acrylate, 3-vinylcyclohexyl(meth)acrylate, cyclohexyl(meth)acrylate, bornyl(meth)acrylate.

The (meth)acrylates with a long-chain alcohol radical can be obtained, for example, by reacting the corresponding acids and/or short-chain (meth)acrylates, especially methyl(meth)acrylate or ethyl(meth)acrylate, with long-chain fatty alcohols, which generally forms a mixture of esters, for example (meth)acrylates with various long-chain alcohol radicals. These fatty alcohols include Oxo Alcohol® 7911, Oxo Alcohol® 7900, Oxo Alcohol® 1100; Alfol® 610, Alfol® 810, Lial® 125 and Nafol® types (Sasol) ; Alphanol® (ICI); Epal® 610 and Epal® 810 (Afton); Linevol® 79, Linevol® 911 and Neodol® 25E (Shell); Dehydad®, Hydrenol® and Lorol® types (Cognis); Acropol® 35 and Exxal® 10 (Exxon Chemicals); Kalcol® 2465 (Kao Chemicals).

The proportion of the (meth)acrylates of the formula (I) in the monomer composition which can be used especially to prepare the X blocks or for grafting is preferably 10 to 100% by weight, more preferably 50 to 100% by weight and most preferably 50 to 99.9% by weight, based on the total weight of the monomer composition.

In addition, the monomer composition may comprise one or more (meth)acrylates of the formula (II)

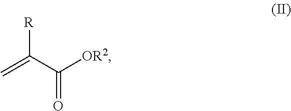

in which R is hydrogen or methyl and R² is an alkyl radical which has 2 to 20 carbon atoms and is substituted by an OH group, or an alkoxylated radical of the formula (III)

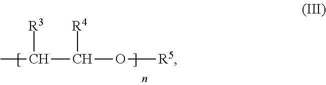

in which R³ and R⁴ are each independently hydrogen or methyl, R⁵ is hydrogen or an alkyl radical having 1 to 40, preferably 1 to 24, carbon atoms and n is an integer from 1 to 90, preferably 1 to 20.

(Meth)acrylates of the formula (II) are known to those skilled in the art. They include hydroxyalkyl (meth)acrylates such as 3-hydroxypropyl methacrylate, 3,4-dihydroxybutyl methacrylate, 2-hydroxyethyl methacrylate, 2-hydroxypropyl methacrylate, 2,5-dimethyl-1,6-hexane-diol(meth)acrylate, 1,10-decanediol(meth)acrylate, 1,2-propanediol(meth)acrylate; polyoxyethylene and polyoxypropylene derivatives of (meth)acrylic acid, such as triethylene glycol(meth)acrylate, tetraethylene glycol(meth)acrylate and tetrapropylene glycol(meth)acrylate.

The proportion of the (meth)acrylates of the formula (II) in the monomer composition which can be used especially to prepare the X blocks or for grafting may preferably be 0 to 50% by weight, more preferably 0.1 to 20% by weight, based on the total weight of the monomer composition.

In addition, the monomer composition may comprise one or more (meth)acrylates of the formula (IV)

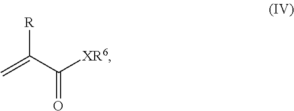

in which R is hydrogen or methyl, X is oxygen or an amino group of the formula —NH— or —NR⁷— in which R⁷ is an alkyl radical having 1 to 40, preferably 1 to 6 carbon atoms, and R⁶ is a linear or branched alkyl radical which has 2 to 20, preferably 2 to 6, carbon atoms and is substituted by at least one —NR⁸R⁹— group where R⁸ and R⁹ are each independently hydrogen, an alkyl radical having 1 to 20, preferably 1 to 6, or in which R⁸ and R⁹, including the nitrogen atom and optionally a further nitrogen or oxygen atom, form a 5- or 6-membered ring which may optionally be substituted by C₁-C₆-alkyl.

The (meth)acrylates or (meth)acrylamides of the formula (IV) include amides of (meth)acrylic acid such as N-(3-dimethylaminopropyl)methacrylamide, N-(diethylphosphono)methacrylamide, 1-methacryloylamido-2-methyl-2-propanol, N-(3-dibutylaminopropyl)methacrylamide, N-t-butyl-N-(diethylphosphono)methacrylamide, N,N-bis(2-diethylaminoethyl)methacrylamide, 4-methacryloylamido-4-methyl-2-pentanol, N-(methoxymethyl)methacrylamide, N-(2-hydroxyethyl)methacrylamide, N-acetylmethacrylamide, N-(dimethylaminoethyl)methacrylamide, N-methyl-N-phenylmethacrylamide, N,N-diethylmethacrylamide, N-methylmethacrylamide, N,N-dimethylmethacrylamide, N-isopropylmethacrylamide, aminoalkyl methacrylates such as tris(2-methacryloyloxyethyl)amine, N-methylformamidoethyl methacrylate, 2-ureidoethyl methacrylate; heterocyclic (meth)acrylates such as 2-(1-imidazolyl)ethyl(meth)acrylate, 2-(4-morpholinyl)ethyl(meth)acrylate and 1-(2-methacryloyloxyethyl)-2-pyrrolidone.

The proportion of the (meth)acrylates of the formula

(IV) in the monomer composition which can be used especially to prepare the X blocks or for grafting is preferably 0 to 15% by weight, more preferably 0.1 to 5% by weight, based on the total weight of the monomer composition.

In addition, the monomer composition may comprise styrene compounds. These include styrene, substituted styrenes with an alkyl substituent in the side chain, for example α-methylstyrene and α-ethylstyrene, substitute styrenes with an alkyl substituent on the ring, such as vinyltoluene and p-methylstyrene, halogenated styrenes, for example monochlorostyrenes, dichlorostyrenes, tribromostyrenes and tetrabromostyrenes.

In addition, the monomer compositions may comprise heterocyclic vinyl compounds such as 2-vinylpyridine, 3-vinylpyridine, 2-methyl-5-vinylpyridine, 3-ethyl-4-vinylpyridine, 2,3-dimethyl-5-vinylpyridine, vinylpyrimidine, vinylpiperidine, 9-vinylcarbazole, 3-vinylcarbazole, 4-vinylcarbazole, 1-vinylimidazole, 2-methyl-1-vinylimidazole, N-vinylpyrrolidone, 2-vinyl-pyrrolidone, N-vinylpyrrolidine, 3-vinylpyrrolidine, N-vinylcaprolactam, N-vinylbutyrolactam, vinyloxolane, vinylfuran, vinylthiophene, vinylthiolane, vinylthiazoles and hydrogenated vinylthiazoles, vinyloxazoles and hydrogenated vinyloxazoles.

In addition to styrene compounds and (meth)acrylates, preferred monomers are especially monomers which have dispersing effects, for example the aforementioned heterocyclic vinyl compounds and (meth)acrylates of the formula (II) or (IV). The term “dispersing effects” relates especially to the property of keeping suspended particles, for example soot particles, particles which have formed as a result of oxidation of mineral oil, or metal particles, suspended in a mineral oil or lubricant oil. These monomers are also referred to as dispersing monomers.

The aforementioned ethylenically unsaturated monomers can be used individually or as mixtures. It is additionally possible to vary the monomer composition during the polymerization in order to obtain defined structures, for example block copolymers. The weight ratio of the parts of the dispersing component which are compatible with the polyolefins, especially of the A blocks, relative to the parts of the dispersing component which are incompatible with the polyolefins, especially the X blocks, may be within wide ranges. In general, this ratio is in the range from 50:1 to 1:50, especially 20:1 to 1:20 and more preferably 10:1 to 1:10.

The preparation of the dispersing components described above is known in the technical field. For example, the preparation can be effected by means of polymerization in solution. Such processes are described, inter alia, in DE-A 12 35 491, BE-A 592 880, U.S. Pat. No. 4,281,081, U.S. Pat. No. 4,338,418 and U.S. Pat. No. 4,290,025.

This can be done by initially charging a suitable reaction vessel, appropriately equipped with stirrer, thermometer, reflux condenser and metering line, with a mixture of the polyolefin, especially an OCP or an HSD, and one or more of the monomers detailed above.

On completion of dissolution under an inert atmosphere, for example nitrogen, while heating, for example to 110° C., a proportion of a free-radical initiator which is customary per se, for example from the group of the peresters, is used, at first, for example, approx. 0.7% by weight based on the monomers.

Thereafter, a mixture of the residual monomers with addition of further initiator, for example approx. 1.3% by weight based on the monomers, is metered in over several hours, for example 3.5 hours. Appropriately, a little further initiator is supplied a certain time after the feeding has ended, for example after 2 hours. The total polymerization time can be assumed, as a guide value, for example, to be approx. 8 hours. After the end of polymerization, the mixture is appropriately diluted with a suitable solvent, for example mineral oil, a vegetable oil or a phthalic ester such as dibutyl phthalate. In general, a virtually clear, viscous solution is obtained.

In addition, the polymer dispersions can be produced in a kneader, an extruder or a static mixer. The treatment in the machine under the influence of the shear forces, the temperature and the initiator concentration causes a degradation in the molecular weight of the polyolefin, especially of the OCP or HSD.

Examples of initiators suitable in the graft copolymerization are cumene hydroperoxide, dicumyl peroxide, benzoyl peroxide, azodiisobutyronitrile, 2,2-bis(t-butylperoxy)butane, diethyl peroxydicarbonate and tert-butyl peroxide. The processing temperature is preferably between 80° C. and 350° C. The residence time in the extruder or kneader is preferably between 1 minute and 10 hours.

The longer the dispersion is treated in the kneader or extruder, the lower the molecular weight will be. The temperature and the concentration of free radical-forming initiators can be set according to the desired molecular weight. The inventive solvent-free polymer-in-polymer dispersion can be converted by processing in suitable carrier media to a readily manageable liquid polymer/polymer emulsion.

The proportion of components B) is generally up to 30% by weight, and this proportion is especially in the range from 5 to 15% by weight, without any intention that this should impose a restriction. The use of greater amounts of component B) is frequently uneconomic. Smaller amounts lead in many cases to a lower stability of the polymer dispersion.

Component C)

Component C) is essential to the success of the present invention. Mineral oils are known per se and commercially available. They are generally obtained from petroleum or crude oil by distillation and/or refining and optionally further purification and finishing processes, the term mineral oil including the higher-boiling fractions in particular of crude oil or petroleum. In general, the boiling point of mineral oil is higher than 200° C., preferably higher than 300° C., at 5000 Pa. Production by low-temperature carbonization of shale oil, coking of hard coal, distillation of brown coal with exclusion of air, and hydrogenation of hard or brown coal is likewise possible. A small proportion of mineral oils is also produced from raw materials of vegetable origin (for example from rapeseed, jojoba) or animal origin (for example neatsfoot oil). Accordingly, mineral oils have, according to their origin, different proportions of aromatic, cyclic, branched and linear hydrocarbons.

In general, a distinction is drawn between paraffin-base, naphthenic and aromatic fractions in crude oils or mineral oils, the term “paraffin-base fraction” representing longer-chain or highly branched isoalkanes, and “naphthenic fraction” representing cycloalkanes. In addition, mineral oils have, according to their origin and finishing, different proportions of n-alkanes, isoalkanes having a low degree of branching, known as mono-methyl-branched paraffins, and compounds having heteroatoms, in particular O, N and/or S, to which a degree of polar properties are attributed. However, the assignment is difficult, since individual alkane molecules may have both long-chain branched groups and cycloalkane radicals, and aromatic parts. For the purposes of the present invention, the assignment can be effected to DIN 51 378, for example. Polar fractions can also be determined to ASTM D 2007. The proportion of n-alkanes in preferred mineral oils is less than 3% by weight, the fraction of O-, N- and/or S-containing compounds less than 6% by weight. The fraction of the aromatics and of the mono-methyl-branched paraffins is generally in each case in the range of 0 to 40% by weight. In one interesting aspect, mineral oil comprises mainly naphthenic and paraffin-base alkanes which have generally more than 13, preferably more than 18 and most preferably more than carbon atoms. The fraction of these compounds is generally ≧60% by weight, preferably 80% by weight, without any intention that this should impose a restriction. A preferred mineral oil contains 0.5 to 30% by weight of aromatic fractions, 15 to 40% by weight of naphthenic fractions, 35 to 80% by weight of paraffin-base fractions, up to 3% by weight of n-alkanes and 0.05 to 5% by weight of polar compounds, based in each case on the total weight of the mineral oil.

An analysis of particularly preferred mineral oils, which was effected by means of conventional processes such as urea separation and liquid chromatography on silica gel, shows, for example, the following constituents, the percentages relating to the total weight of the particular mineral oil used:

n-alkanes having approx. 18 to 31 carbon atoms:

0.7-1.0%,

slightly branched alkanes having 18 to 31 carbon atoms:

1.0-8.0%,

aromatics having 14 to 32 carbon atoms:

0.4-10.7%,

iso- and cycloalkanes having 20 to 32 carbon atoms:

60.7-82.4%,

polar compounds:

0.1-0.8%,

loss:

6.9-19.4%.

Valuable information with regard to the analysis of mineral oils and a list of mineral oils which have a different composition can be found, for example, in Ullmann's Encyclopedia of Industrial Chemistry, 5th Edition on CD-ROM, 1997, under “lubricants and related products”.

In a particular aspect of the present invention, the polymer dispersion contains preferably 2 to 40% by weight, especially 5 to 30% by weight and more preferably 10 to 20% by weight of mineral oil.

Component D)

Component D) is obligatory for the present polymer dispersion, this component being formed from at least one glyceryl ester derived from an unsaturated carboxylic acid having 8 to 30 carbon atoms. At least one of the radicals derived from a carboxylic acid preferably has 12 to 24 and more preferably 14 to 20 carbon atoms.

In the present context, a glyceryl ester is understood to mean an ester of a carboxylic acid with glycerol (propane-1,2,3-triol). It is possible with preference for two or three of the hydroxyl groups of glycerol to be esterified with two or three carboxylic acids which have 8 to 30, preferably 12 to 24 and more preferably to 20 carbon atoms. Of particular interest are especially triglyceryl esters which have three groups derived from carboxylic acids having 12 to 24, more preferably 14 to 20, carbon atoms.

Preferred triglyceryl esters have especially the formula (V)

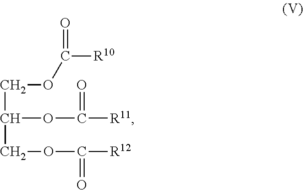

in which the R¹⁰, R¹¹ and R¹² radicals are each independently a hydrocarbon radical having 7 to 29, preferably 11 to 23 and more preferably 13 to 19 carbon atoms, and at least one of the R¹⁰, R¹¹ and R¹² radicals comprises at least one double bond.

In the present context, hydrocarbon radicals refer especially to saturated and/or unsaturated radicals which preferably consist of carbon and hydrogen. These radicals may be cyclic, linear or branched. These include especially alkyl radicals and alkenyl radicals, where the alkenyl radicals may comprise one, two, three or more carbon-carbon double bonds.

The preferred alkyl radicals include especially the heptyl, octyl, 1,1,3,3-tetramethylbutyl, nonyl, decyl, undecyl, dodecyl, tridecyl, tetradecyl, pentadecyl, hexadecyl, heptadecyl, octadecyl, nonadecyl, eicosyl and the cetyleicosyl group.

Examples of alkenyl radicals with one carbon-carbon double bond include the heptenyl, octenyl, nonenyl, decenyl, undecenyl, dodecenyl, tridecenyl, tetradecenyl, pentadecenyl, hexadecenyl, heptadecenyl, octadecenyl, nonadecenyl, eicosenyl and the cetyleicosenyl group.

The alkenyl radicals having two, three or more carbon-carbon double bonds include the 8,11-heptadecadienyl and the 8,11,14-heptadecatrienyl group.

The hydrocarbon radicals listed above may have substituents and/or heteroatoms. These include especially groups which comprise oxygen, nitrogen and/or sulfur, for example hydroxyl groups, thiol groups or amino groups. The proportion of these groups should, however, be sufficiently low that the properties of the glycerides are not adversely affected.

The glyceryl esters of component D) comprise at least one radical derived from an unsaturated carboxylic acid having 8 to 30 carbon atoms. As already explained, the glyceryl ester may additionally comprise radicals derived from saturated carboxylic acids. The proportion of radicals derived from unsaturated carboxylic acids having 8 to 30, preferably 12 to 24 and more preferably to 20 carbon atoms is preferably at least 20% by weight, more preferably at least 60% by weight and most preferably at least 80% by weight, based on the total weight of the acids from which the glyceryl ester is derived. If a mixture of different glyceryl esters is used, the values for unsaturated fatty acids given above are based on the fatty acid spectrum obtained after a hydrolysis.

The preferred saturated carboxylic acids from which the glyceryl esters according to component D) are derived include capric acid, lauric acid, myristic acid, palmitic acid, margaric acid, stearic acid, arachic acid, behenic acid, lignoceric acid and cerotic acid.

Examples of monounsaturated carboxylic acids include palmitoleic acid, oleic acid, elaidic acid, vaccenic acid, eicosenoic acid, cetoleic acid, nervonic acid, erucic acid, petroselic acid and ricinoleic acid.

In addition, the glyceryl ester may be derived from polyunsaturated fatty acids. These include linoleic acid, linolenic acid and eleostearic acid.

In a particular aspect of the present invention, it is possible to use, as component D), a glyceryl ester which comprises at least 5% by weight, preferably at least 10% by weight, of oleic acid and at least 10% by weight, preferably at least 20% by weight, of linoleic acid, based on the total weight of the acids from which the glyceryl ester is derived.

These values should be interpreted as average values if a mixture of different glyceryl esters is used.

Of particular interest are especially glyceryl esters which comprise a low proportion of saturated fatty acids. The proportion of the saturated fatty acids may preferably be at most 50% by weight, more preferably at most 30% by weight and most preferably at most 10% by weight, based on the total weight of the acids from which the glyceryl ester is derived. These values should be interpreted as average values if a mixture of different glyceryl esters is used.

In an appropriate modification of the present invention, it is possible with preference to use glyceryl esters which have a melting point less than or equal to 15° C., more preferably less than or equal to 5° C. and most preferably less than or equal to 0° C. The melting point can be determined to ASTM D 87.

Particularly advantageously, it is also possible to use glyceryl esters which have a cloud point less than or equal to 5° C., more preferably less than or equal to 0° C., the cloud point being determinable to ASTM D 2500.

The viscosity of the glyceryl ester used in accordance with the invention may preferably be at most 100 cSt, more preferably at most 40 cSt, the viscosity being determinable at 40° C. to ASTM D 445.

According to the invention, a specific glyceryl ester can be used as component D). In general, the glyceryl esters are, however, used as a mixture of different esters, as present, by way of example, in vegetable oils. The values given above may therefore relate to the glyceryl ester mixture used in each case.

The inventive polymer dispersion may preferably comprise at least one vegetable oil. In this context, it is also possible to use vegetable oils suitable only for industrial purposes. Accordingly, it is also possible to use vegetable oils with a high proportion of impurities.

The preferred vegetable oils include especially rapeseed oil, coriander oil, soybean oil, cottonseed oil, sunflower oil, castor oil, olive oil, peanut oil, corn oil, almond oil, palm kernel oil, coconut oil, mustardseed oil. These oils may find use individually or as a mixture to prepare the present dispersions. These oils can be obtained from naturally occurring plants, cultivated plants or genetically modified plants.

The proportion of glyceryl ester in the polymer dispersion may be within a wide range, the dispersion comprising preferably 20 to 80% by weight, more preferably 30 to 70% by weight, of glyceryl esters according to component D), based on the total weight of the dispersion.

The weight ratio of mineral oil to the glyceryl esters according to component D) may be within wide ranges. This ratio is more preferably in the range from 2:1 to 1:25, especially 1:2 to 1:10.

The proportion of components C) and D) in the concentrated polymer dispersion may be within wide ranges, this proportion depending especially on the polyolefins and dispersing components used. In general, the proportion of components C) and D) together is 79 to 25% by weight, preferably less than 70, especially to 40% by weight, based on the overall polymer dispersion.

In addition to the aforementioned components, the inventive polymer dispersion may comprise further additives. These include especially substances present in vegetable oils. It is therefore possible in many cases to use vegetable oils without a complex purification.

The inventive polymer dispersions preferably comprise stabilizers and/or antioxidants. These substances are known per se, and include especially oxygen-containing compounds, for example hydroquinones, hydroquinone ethers such as hydroquinone monomethyl ether or di-tert-butylpyrocatechol, or sterically hindered phenols, and nitrogen-containing compounds such as phenothiazine, p-phenylenediamine and methylene blue. The proportion of antioxidants is preferably in the range from 0 to 4% by weight, more preferably in the range from 0.1 to 2% by weight, based on the total weight of the polymer dispersion.

An inventive polymer dispersion may further comprise further solvents and/or carrier media which are known from the aforementioned prior art.

In addition, the polymer dispersion of the present invention may comprise compounds with a dielectric constant greater than or equal to 9, especially greater than or equal to 20 and more preferably greater than or equal to 30. It has been found that, surprisingly, the addition of these compounds allows the viscosity of the polymer dispersion to be lowered. This makes it possible especially to adjust the viscosity to a given value.

The dielectric constant can be determined by methods specified in Handbook of Chemistry and Physics, David R. Lide, 79th Edition, CRS Press, the dielectric constant being measured at 20° C.

The particularly suitable compounds include water, glycols, especially ethylene glycol, 1,2-propylene glycol, 1,3-propylene glycol, polyethylene glycol; alcohols, especially methanol, ethanol, butanol, glycerol; ethoxylated alcohols, for example 2-tuply ethoxylated butanol, 10-tuply ethoxylated methanol; amines, especially ethanolamine, 1,2-ethanediamine and propanolamine; halogenated hydrocarbons, especially 2-chloroethanol, 1,2-dichloroethane, 1,1-dichloroacetone; ketones, especially acetone.

The proportion of the above-described compounds in the polymer dispersion may be within wide ranges. In general, the polymer dispersion comprises up to 15% by weight, especially 0.3 to 5% by weight, of compounds with a dielectric constant greater than or equal to 9.

The polymer dispersions can be produced by known processes, these processes being detailed in the aforementioned prior art documents. For example, the present polymer dispersions can be produced by dispersing component A) in a solution of components B) employing shear forces at a temperature in the range from 50 to 150° C., more preferably 60 to 120° C. The solution of components B) generally comprises components C) and D).

Particularly advantageously, the polyolefin according to component A) can be added to the solution in solid form.

In this context, relatively short dispersing times are sufficient in many cases, which are preferably within the range from 1 to 10 h, more preferably 1 to 6 h. The shear energies used are likewise in many cases smaller than necessary in conventional systems. The power input may advantageously be at most 2 kW/m³, more preferably at most 1 kW/m³, based on the dispersing of 1 kg of polyolefin in a solution which contains 0.5 kg of dispersing component, 0.1 kg of mineral oil and 1 kg of glyceryl ester.

The present invention will be illustrated hereinafter with reference to examples, without any intention that this shall impose a restriction.

### EXAMPLE 1

In a 2 liter four-neck flask with stirrer, thermometer and reflux condenser, 190 g of an ethylene-propylene copolymer (e.g. Dutral CO 038) of thickening action 11.0 mm/s² in relation to KV100 in a mixture consisting of 680 g of a 150N oil and 130 g of a 100N oil are weighed in and dissolved at 100° C. within 10-12 h.

61.7 g of a mixture consisting of alkyl methacrylates with alkyl substituents of chain length C10 to C18 are added to 555.0 g of this solution, and the reaction mixture is inertized by adding dry ice. On attainment of the polymerization temperature of 100° C., 2.06 g of tert-butyl peroxy-2-ethylhexanoate are added, and, simultaneously, a monomer feed consisting of 883.3 g of the composition detailed above and 11.48 g of tert-butyl peroxy-2-ethylhexanoate is started and added homogeneously over a feed time of 3.5 h. Two hours after the end of feeding, 1.89 g of tert-butyl peroxy-2-ethylhexanoate are added and the mixture is stirred at 100° C. for a further two hours.

In a 1 liter Witt jar with Intermig stirrer, 152.8 g of the solution prepared, 179.1 g of refined vegetable oil (e.g. soybean oil), 34.0 g of an ethylene-propylene copolymer (e.g. Dutral CO 038 degraded to a KV100 of 10.50 cSt), 134.1 g of a further ethylene-propylene copolymer (e.g. Dutral CO 058 degraded to a KV100 of 11.35 cSt) and 6.11 g of a stabilizer (e.g. Irganox 1076) are weighed in. A dispersion is formed at 100° C. and 150 rpm within 12-18 h. Subsequently, 400.0 g of the dispersion formed are diluted to polymer content 45% by adding 88.9 g of the refined vegetable oil and the mixture is stirred for a further half hour. The kinematic viscosity of the product thus produced at 100° C. (KV100) to DIN 51 562 (Ubbelohde viscometer) is 3100 cSt. The KV100 of a 3.42% solution of the product in a 150N oil is 11.87 cSt.

1. A polymer dispersion comprising
A) at least one dispersed polyolefin,
B) at least one dispersing component,
C) mineral oil and
D) at least one glyceryl ester derived from an unsaturated carboxylic acid having 8 to 30 carbon atoms.

2. The polymer dispersion as claimed in claim 1, wherein component A) comprises one or more olefin copolymers, hydrogenated polyisoprene, hydrogenated copolymers of butadiene/isoprene, or hydrogenated copolymers of butadiene/isoprene and styrene.

3. The polymer dispersion as claimed in claim 1, wherein the polymer dispersion comprises at least 30% by weight of component A).

4. The polymer dispersion as claimed in claim 1, wherein component B) is a copolymer which comprises one or more A blocks and one or more X blocks, said A block comprising olefin copolymer sequences, hydrogenated polyisoprene sequences, hydrogenated copolymers of butadiene/isoprene or hydrogenated copolymers of butadiene/isoprene and styrene, and
said X block comprising polyacrylate, polymethacrylate, styrene, α-methylstyrene or N-vinylheterocyclic sequences and/or sequences of mixtures of polyacrylate, polymethacrylate, styrene, a-methylstyrene or N-vinylheterocycles.

5. The polymer dispersion as claimed in claim 4, wherein the weight ratio of the A blocks to the X blocks is in the range from 20:1 to 1:20.

6. The polymer dispersion as claimed in at least one of claim 1, wherein component B) is obtained by the graft copolymerization of a monomer composition comprising (meth)acrylates and/or styrene compounds onto polyolefins according to component A).

7. The polymer dispersion as claimed in claim 6, wherein the monomer composition used comprises one or more (meth)acrylates of the formula (I) 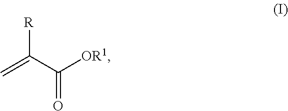
in which R is hydrogen or methyl and R¹ is hydrogen or a linear or branched alkyl radical having 1 to 40 carbon atoms,
and/or one or more (meth)acrylates of the formula (II) 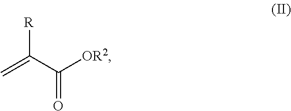
in which R is hydrogen or methyl and R² is an alkyl radical which has 2 to 20 carbon atoms and is substituted by an OH group, or an alkoxylated radical of the formula (IV) 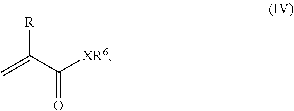
in which R³ and R⁴ are each independently hydrogen or methyl, R⁵ is hydrogen or an alkyl radical having 1 to 40 carbon atoms and n is an integer from 1 to 90,
and/or one or more (meth)acrylates of the formula (IV) 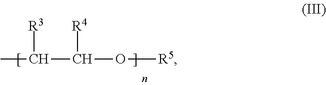
in which R is hydrogen or methyl, X is oxygen or an amino group of the formula —NH— or —NR⁷— in which R⁷ is an alkyl radical having 1 to 40 carbon atoms, and R⁶ is a linear or branched alkyl radical which has 2 to 20 carbon atoms and is substituted by at least one —NR⁸R⁹— group where R⁸ and R⁹ are each independently hydrogen, an alkyl radical having 1 to 20 carbon atoms, or in which R⁸ and R⁹, including the nitrogen atom and optionally a further nitrogen or oxygen atom, form a 5- or 6-membered ring which may optionally be substituted by C₁-C₆-alkyl.

8. The polymer dispersion as claimed in claim 6, wherein the monomer composition used in the graft reaction comprises dispersing monomers.

9. The polymer dispersion as claimed in claim 1, wherein the polymer dispersion comprises up to 30% by weight of component C).

10. The polymer dispersion as claimed in claim 1, wherein the polymer dispersion comprises 2 to 40% by weight of component C).

11. The polymer dispersion as claimed in claim 1, wherein the polymer dispersion comprises, as component D), at least one glyceryl ester which has at least two groups derived from carboxylic acids having 12 to 24 carbon atoms.

12. The polymer dispersion as claimed in claim 1, wherein component D) comprises at least one glyceryl ester according to the following formula (V) 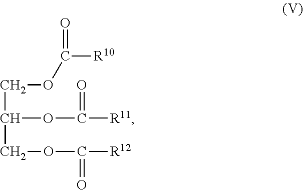
in which the R¹⁰, R¹¹ and R¹² radicals are each independently a hydrocarbon radical having 7 to 29 carbon atoms, and at least one of the R¹⁰, R¹¹ and R¹² radicals comprises at least one double bond.

13. The polymer dispersion as claimed in claim 1, wherein the proportion of radicals derived from unsaturated carboxylic acids having 8 to 30 carbon atoms is at least 60% by weight, based on the total weight of the acids from which the glyceryl ester is derived.

14. The polymer dispersion as claimed in claim 13, wherein the proportion of radicals derived from unsaturated carboxylic acids having 12 to 24 carbon atoms is at least 80% by weight, based on the total weight of the acids from which the glyceryl ester is derived.

15. The polymer dispersion as claimed in claim 1, wherein the proportion of saturated fatty acids is at most 30% by weight, based on the total weight of the acids from which the glyceryl ester is derived.

16. The polymer dispersion as claimed in claim 15, wherein the proportion of saturated fatty acids is at most 10% by weight, based on the total weight of the acids from which the glyceryl ester is derived.

17. The polymer dispersion as claimed in claim 1, wherein the glyceryl ester comprises a radical derived from the group consisting of palmitoleic acid, oleic acid, elaidic acid, vaccenic acid, eicosenoic acid, cetoleic acid, nervonic acid, erucic acid, petroselic acid, ricinoleic acid and mixtures thereof.

18. The polymer dispersion as claimed in claim 1, wherein the glyceryl ester comprises a radical derived from the group consisting of linoleic acid, linolenic acid, eleostearic acid and mixtures thereof.

19. The polymer dispersion as claimed in claim 1, wherein the glyceryl ester comprises at least 10% by weight of oleic acid and at least 20% by weight of linoleic acid, based on the total weight of the acids from which the glyceryl ester is derived.

20. The polymer dispersion as claimed in claim 1, wherein the polymer dispersion comprises, as component D), at least one vegetable oil.

21. The polymer dispersion as claimed in claim 20, wherein the vegetable oil is selected from rapeseed oil, coriander oil, soybean oil, cottonseed oil, sunflower oil, castor oil, olive oil, peanut oil, corn oil, almond oil, palm kernel oil, coconut oil, and mustardseed oil.

22. The polymer dispersion as claimed in claim 1, wherein the glyceryl ester according to component D) has a melting point less than or equal to 0° C.

23. The polymer dispersion as claimed in claim 1, wherein the glyceryl ester according to component D) has a cloud point less than or equal to 5° C.

24. The polymer dispersion as claimed in claim 1, wherein the glyceryl ester according to component D) has a viscosity less than or equal to 40 cSt, the viscosity being determinable at 40° C. to ASTM D 445.

25. The polymer dispersion as claimed in claim 1, wherein the polymer dispersion comprises 30 to 70% by weight of glyceryl esters according to component D), based on the total weight of the dispersion.

26. The polymer dispersion as claimed in claim 1, wherein the weight ratio of component C) to component D) is in the range from 1:2 to 1:10.

27. The polymer dispersion as claimed in claim 1, wherein the polymer dispersion comprises stabilizers and/or antioxidants.

28. The polymer dispersion as claimed in claim 27, wherein the antioxidants are selected from hydroquinone, hydroquinone monomethyl ether, phenothiazine and sterically hindered phenols.

29. The polymer dispersion as claimed in claim 27, wherein the polymer dispersion contains at most 2% by weight of stabilizers and/or antioxidants, based on the total weight of the polymer dispersion.

30. The polymer dispersion as claimed in claim 1, wherein the polymer dispersion comprises a compound which has a dielectric constant greater than or equal to 9.

31. The polymer dispersion as claimed in claim 30, wherein the compound having a dielectric constant greater than or equal to 9 is selected from water, ethylene glycol, polyethylene glycol and/or alcohol.

32. A process for producing polymer dispersions as claimed in claim 1, wherein at least one polyolefin is dispersed employing sheer forces in a solution which comprises at least one dispersing component according to component B), mineral oil according to component C) and at least one glyceryl ester according to component D).

33. The process as claimed in claim 32, wherein component A) is added to the solution as a solid.

34. The process as claimed in claim 32, wherein the dispersing is effected at a temperature in the range from 60 to 120° C.

35. The process as claimed in claim 32, wherein the dispersing is effected over a time period in the range from 1 to 6 h.

36. The process as claimed in claim 32, wherein the dispersing is effected with a power input of at most 1 kW/m³, based on the dispersing of 1 kg of polyolefin in a solution which contains 0.5 kg of dispersing component, 0.1 kg of mineral oil and 1 kg of glyceryl ester.

37. An additive for lubricant oil formulations comprising the polymer dispersion as claimed claim 1.
